(19) United States
(12) Patent Application Publication
(10) Pub. No.: US 2011/0220215 A1
(43) Pub. Date: Sep. 15, 2011

(54) HYDRO-GENERATOR SOFT START

(76) Inventors: Randall Paul Schmitt, Clinton Township, MI (US); Jeff Belz, Eastpointe, MI (US)

(21) Appl. No.: 12/722,729

(22) Filed: Mar. 12, 2010

(51) Int. Cl. F16K 15/02

(52) U.S. Cl. 137/12; 137/535

(57) ABSTRACT

A mechanism for minimizing shock in a fluid has a housing, a valve disposed in the housing for regulating a flow of the fluid, a spring that urges the valve to oppose the fluid flow, and, a reservoir disposed in the housing downstream of the valve. The valve meters the flow of fluid from the reservoir if the valve moves in reaction to the flow of the fluid.

### BACKGROUND

As plumbing fixtures add features, such as electronic controls, sensors and the like, the question of how those features are to be powered has arisen. Line power may not be preferred in many areas because of a concern that higher electrical power and water may create a hazard. Some applications use smaller, lower-power hydro-generators to provide the necessary electrical power.

### SUMMARY

According to an example, a mechanism for minimizing shock in a fluid has a housing, a valve disposed in the housing for regulating a flow of the fluid, a spring disposed in the housing that urges the valve to oppose the fluid flow, and, a reservoir disposed in the housing downstream of the valve. The valve meters the flow of fluid from the reservoir if the valve moves in reaction to the flow of the fluid.

According to a further example, a method for damping flow to a fixture includes exposing a valve to a flow of fluid, opposing the flow of fluid with a spring that urges the valve against the fluid flow, opposing the flow of fluid by metering a flow of fluid from a reservoir toward the fixture as the valve moves from a first position in response to the flow of fluid, and metering the flow of fluid as the valve moves.

These and other features of the present invention can be best understood from the following specification and drawings, the following of which is a brief description.

### BRIEF DESCRIPTION OF THE DRAWINGS

FIG. 1 is a schematic partially broken away depiction of a Prior Art hydro-generator.

FIG. 2 is a soft start mechanism shown in section in a closed position.

FIG. 3 is a perspective view of partially in section of the soft start mechanism of FIG. 2 in the open position.

### DETAILED DESCRIPTION OF THE PREFERRED EMBODIMENT

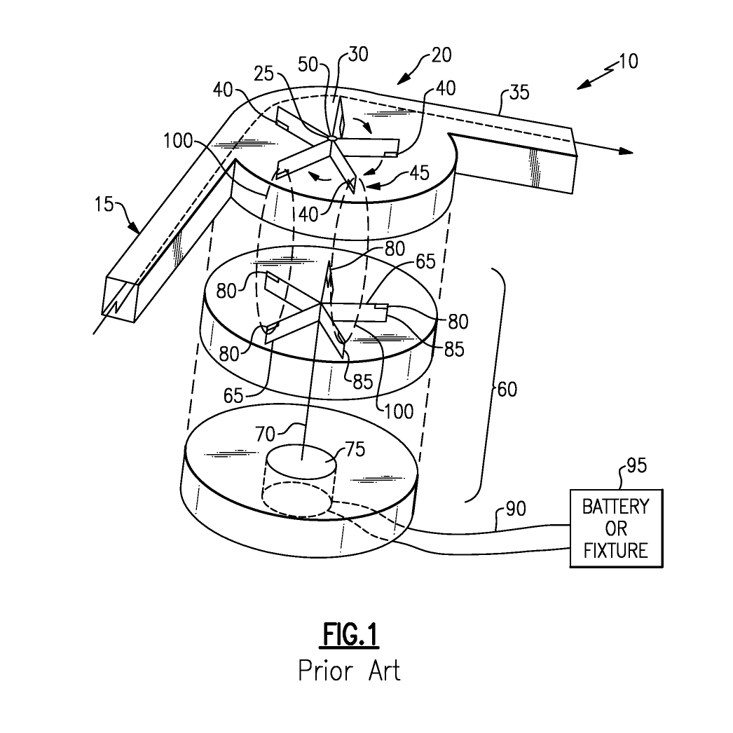

Referring now to FIG. 1, an example of a prior art embodiment of a typical hydro-generator 10 is shown. The hydro-generator 10 has an inlet section 15, a sealed rotation chamber 20, a rotor 25 holding a plurality of blades 30 and an outlet 35. Water flows through the inlet 15 into the rotation chamber 20, uses its motive force to rotate the blades 30, and exits through the outlet 35.

Each blade 30 has a magnet 40 imbedded in an outboard and lower portion 45 thereof. The rotor 25 is mounted to a hub 50 maintained within the sealed chamber. The rotation chamber has a bottom wall 55, which does not diminish magnetic fields, to separate it from a generator portion 60.

The generator portion 60 houses a plurality of vanes 65 that are designed to be in register with the blades 30 within the rotation chamber 20. The vanes 65 within the generator portion are mounted on a shaft 70 that connects to a generator 75 as is known in the art. The vanes 65 each have a magnet 80 that is located at an outboard and upper portion 85 thereof also to be in register with magnets 40 of opposite polarity in the rotation chamber. Electricity created by the generator 75 passes through the wires to be used or stored by a battery or a plumbing fixture 95 or the like.

The generator 75 creates electrical power because water that flows into the rotation chamber 20, rotates the blades 30 which in turn through operation of a magnetic field 100 between the magnets 40 in the blades 30 and the magnets 80 in the vanes 65. The vanes 65 rotate the shaft 70 that rotates a rotor (not shown) within the generator 75 to generate electric current as is well known in the art.

However, if the water flowing through the inlet section 15 into the rotation chamber 20 comes through too quickly, there is a possibility that the force of that water will overcome the attraction of the magnetic field 100 between the magnets 40, 80 and cause the blades 30 in the rotation chamber to get out of register with the vanes 65 in the generator portion and the vanes 65 will not rotate. Because the blades 30 usually rotate for a short amount of time while the water is being used, the vanes 65 in the generator section 60 may never catch up to the blades 30 in the rotation chamber so that very little, if any, electricity is generated by the generator 75.

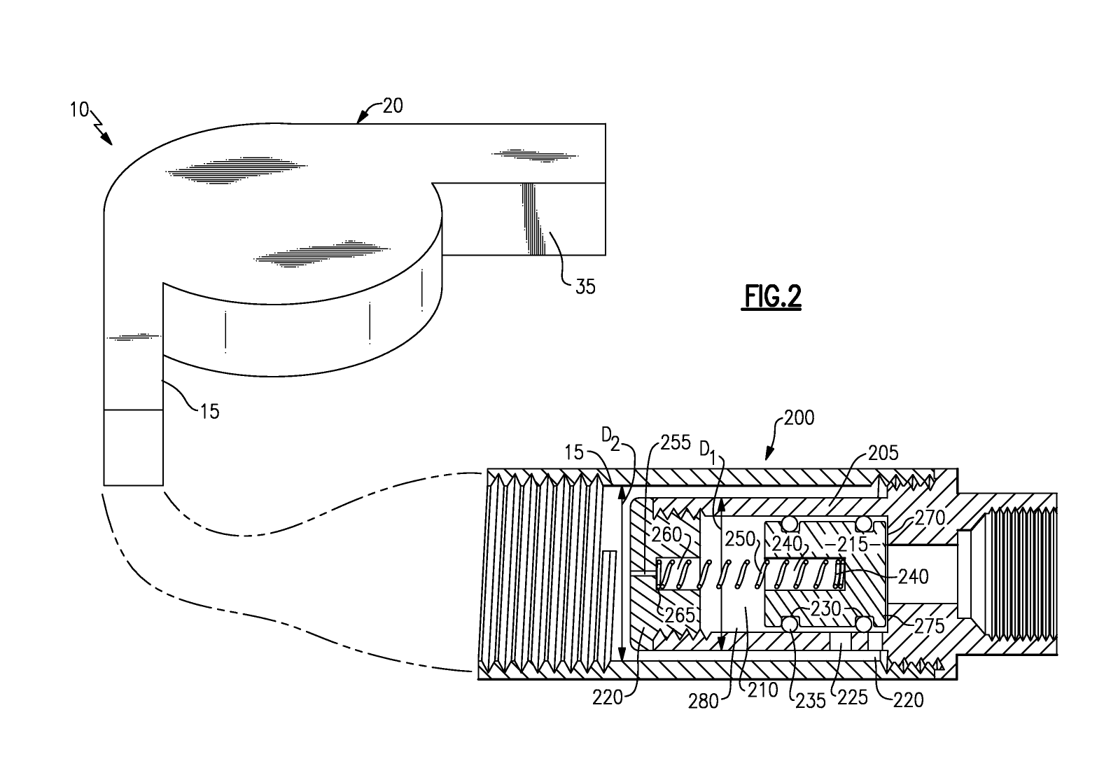

Referring now to FIG. 2, a soft start mechanism 200 for use with a hydro-generator 10 is shown upstream of the hydro-generator 10. This soft start mechanism 200 has a housing 205 having a diameter D1 that is less than the inner diameter D2 of the inlet section 15. The cylindrical housing has a major bore 210 for holding a valve 215, a plug 220 sealing the housing 205, a pair of axially disposed outlet holes 220, 225 directing water into the inlet section 15, a pair of radial grooves 230, each radial bore housing an o-ring 235, and an axial bore 240 for housing a first end 245 of a spring 250. The first outlet hole 220 is of smaller diameter and is closer to the water source and the second outlet hole 225 is a greater diameter than the first hole and is farther away from the water source than the first outlet hole. The plug 220 has a minor bore 255 extending through a center portion thereof and a major bore 260 for housing a second end 265 of the spring 250. The valve 215 has a face 270 for mating with a land 275 in the housing.

FIG. 2 shows the soft start mechanism 200 in a closed position with the face 270 of the valve 215 mated with the land 275 of the housing 205. In this position there is no flow through the soft start mechanism. There is a reservoir 280 of water in the major bore behind the valve.

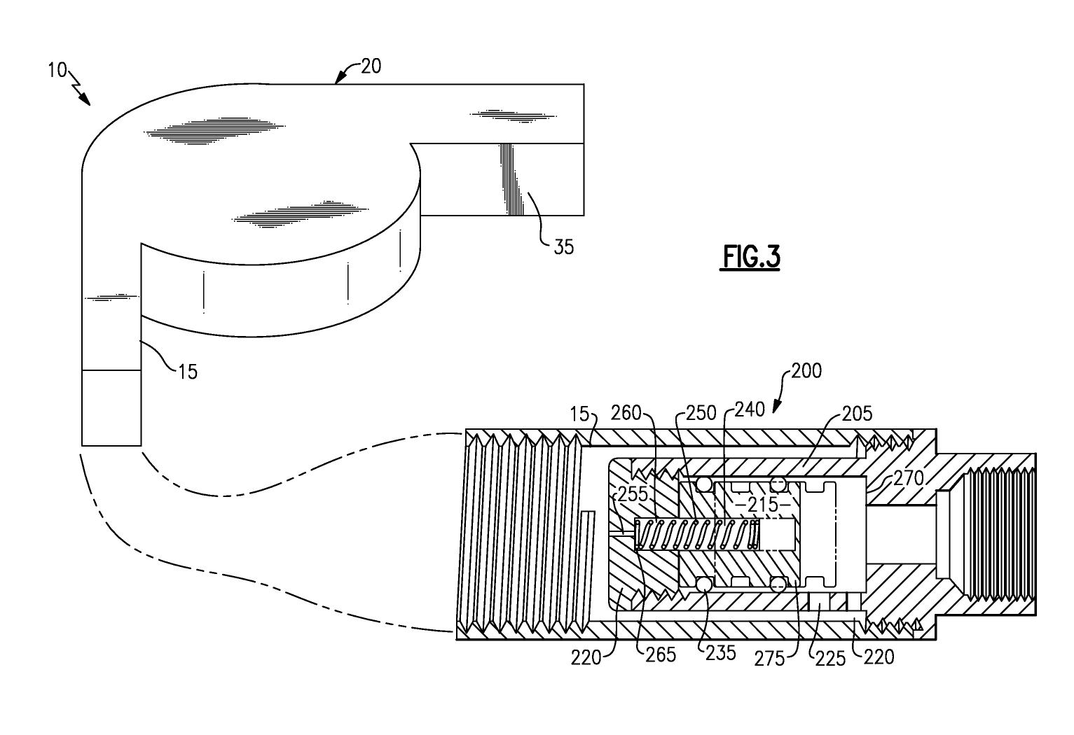

FIG. 3 shows the soft start mechanism 200 in an open position. The valve 215 is forced by water entering the soft start mechanism back against the plug 220 after water is turned on, the spring 250 is compressed and the reservoir 280 of water in the major bore has been forced out of the major bore into the inlet section. The system is open to allow water through both the first and second outlet holes 220, 225.

The soft start module is reset to its initial starting condition as shown in FIG. 2 after the water is turned off, because the spring 250 pushes the valve 215 towards the land and causes water left in the inlet section 15 to be drawn within the replenishing reservoir 280 within the major bore 260 and through the minor bore 255 in the plug 220. When reset, the spring 250 pushes the valve 215 back against the land 275, to shut off the flow from the main water flow source. Flow through first and second outlet holes 220, 225 is also ended.

As a remote valve (not shown) starts water flow, a shock wave of the water flow reacts against the face 270 of the valve 250 causing it to start to move open subject to the limiting force of water escaping through the minor bore 255 in the plug 220 and the resistive force of the spring 250. As the force of the spring 250 is overcome and water escapes from the reservoir 280, the valve move to open flow through the smaller, first outlet hole 220 until the valve passes by the larger, second outlet hole 225, bottoms against the plug and is fully open.

Gradually increasing water flow passing through and from the soft start module passes 200 into and through the inlet section 15 into the hydro-generator 10. As the lower beginning flows pass the blades 30, the blades slowly start turning and stay in registry with the vanes 65 in the generator section 60 causing the vanes to rotate thereby generating electricity by means of generator 75. As the water exits the first outlet hole and then the second outlet hole as a the valve 215 moves, a gradual acceleration of flow allow the magnetic coupling to remain unbroken as the turbine and generator accelerate to maximum speed.

Typical soft start devices 200 usually rely on spring pressure alone to restrict the water movement within a pipe. However, much of the energy in the water flow is wasted overcoming this spring resistance and not driving the hydro-generator. This improved start module shown herein uses a relatively weaker spring 250 for resisting flow, resetting the valve and filling the reservoir and relies on discharging the reservoir through the minor bore to provide the required resistance to initial flow. Once the initial delay is accomplished, the soft start module provides reduced restriction to flow due to its weaker spring 250.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims. For instance, though a first outlet hole and a second larger outlet hole are shown, mechanisms for allowing graduated flow as the valve moves, such as more or less radially holes or different sized grooves etc. are contemplated.

What is claimed is:

1. A mechanism for minimizing shock in a fluid comprising;
a housing,
a valve disposed in the housing for regulating a flow of a fluid,
a spring that urges the valve to oppose the flow of the fluid, and
a reservoir disposed in the housing downstream of the valve wherein the valve meters the flow of fluid from the reservoir if the valve moves in reaction to the flow of the fluid.

2. The mechanism of claim 1 further comprising;
a first opening disposed in the housing for metering the flow of a fluid from the housing.

3. The mechanism of claim 2 further comprising;
a second opening disposed in the housing for metering the flow of a fluid from the housing the second opening being disposed downstream of the second opening.

4. The mechanism of claim 3 wherein the second opening is larger than the first opening.

5. The mechanism of claim 1 wherein the reservoir is defined by the valve, the housing and a plug that closes the housing.

6. The mechanism of claim 5 wherein the plug further comprises an opening for metering fluid therethrough.

7. The mechanism of claim 5 wherein the plug has a bore for housing a portion of the spring.

8. The mechanism of claim 1 wherein the valve has a barrel shape and includes a bore for housing a portion of the spring.

9. The mechanism of claim 8 each wherein the housing has a plug having a bore for housing another portion of the spring.

10. The mechanism of claim 9 wherein the bore of the plug has a hole for metering fluid from the reservoir therethrough.

11. Method for damping flow to a fixture comprising;
exposing a valve to a flow of fluid,
opposing the flow of fluid with a spring that urges the valve against the flow of fluid,
opposing the flow of fluid by metering a flow of fluid from a reservoir toward the fixture as the valve moves from a first position in response to the flow of fluid, and
metering the flow of fluid as the valve moves.

12. The method of claim 11 wherein the metering the flow of fluid includes gradually increasing the flow of fluid as the valve moves.

13. The method of claim 11 wherein the method further comprises;
restoring the valve to the first position if the flow of fluid ceases.

14. The method off claim 11 wherein the fixture is a hydro-generator.
